(19) United States
(12) Patent Application Publication
(10) Pub. No.: US 2008/0169068 A1
(43) Pub. Date: Jul. 17, 2008

(54) Covering bracket for blinds

(75) Inventor: Wen Ying Liang, Changhua Hsien (TW)

Correspondence Address: TROXELL LAW OFFICE PLLC, 5205 LEESBURG PIKE, SUITE 1404, FALLS CHURCH, VA, 22041, US

(73) Assignee: CHING FENG HOME FASHIONS CO., LTD.

(21) Appl. No.: 11/653,427

(22) Filed: Jan. 16, 2007

(51) Int. Cl. E06B 9/17

(52) U.S. Cl. 160/178.1 R

(57) ABSTRACT

A covering bracket for blinds comprises a sealing cover and multiple positioning seats wherein each positioning seat is equipped with a set of elastic hooked legs, each defined by a sliding surface at the inner side, symmetrically extending at both lateral edges of one side thereon for the engagement of the sealing cover therewith. Besides, the positioning seat also includes a set of level-surfaced stop flanges, each defined by a guide recess at the underside, symmetrically protruding at both lateral edges of the other side thereon to precisely locate astride on top of a track of a headrail so that the sealing cover can be accurately positioned in place to conceal a grooved portion of the headrail, achieving the purposes of dustproof and protection of the assembling parts accommodated therein.

### BACKGROUND OF THE INVENTION

The present invention relates to a covering bracket for blinds, comprising a sealing cover and multiple positioning seats wherein each positioning seat is equipped with a set of hooked legs for the engagement of the sealing cover therewith, and a set of level-surfaced stop flanges to astride on top of a track of a headrail so that the sealing cover can be precisely located in place to conceal a grooved portion of the headrail, achieving the purposes of dustproof and protection of the assembling parts accommodated therein as well as decorating the appearance of the track of the headrail thereby.

A conventional window blind 10 includes a headrail 11 having a hollowed-out grooved portion 12 exposed unsheltered as shown in FIG. 1. Over a period of application, dust or dirt tends to accumulate inside the grooved portion 12 of the headrail 11 and stain the assembling parts accommodated therein. Sometimes, via double-sided adhesive tape or fastening agent, a covering plate 14 is directly attached on top of a track 13 of the headrail 11 as shown in FIG. 2 so as to adorn the appearance of the track 13 thereby. However, to clean the grooved portion 12 of the track 13 thereof, the covering plate 14 glued onto the top surface of the track 13 must be torn by hands to detach from the track 13 thereof. As a result, stains of the double-sided adhesive tape or fastening agent will remain in a large amount on the top surface of the track 13, which can cause trouble in the cleaning. Otherwise, the covering plate 14 torn from the track 13 can be destroyed out of use in the process thereof. Moreover, the blind must also be dismantled as a whole so as to retrieve the covering plate 14, which can take a lot of efforts in the operation as well as cause much trouble in the cleaning thereof.

### SUMMARY OF THE PRESENT INVENTION

It is, therefore, the primary purpose of the present invention to provide a blind covering bracket for blinds, comprising a sealing cover and multiple positioning seats wherein the positioning seat is equipped with a set of hooked legs each defined by a sliding surface at the inner side for the engagement of the sealing cover therewith, and a set of level-surfaced stop flanges each defined by a guide recess at the underside thereof to locate astride on top of a track of a headrail so that the sealing cover can be precisely positioned in place to conceal a grooved portion of the headrail, achieving the purposes of dustproof and protection of the assembling parts accommodated therein as well as decorating the appearance of the track of the headrail. Besides, the covering bracket can be flexibly assembled or dismantled, facilitating easy and convenient application thereby.

It is, therefore, the second purpose of the present invention to provide a covering bracket for blinds wherein the positioning seat can have the stop flanges with the guide recesses flexibly molded to match to various-sized tracks of the headrail for different-type blinds, facilitating more flexible assembly without any limitations thereof.

### BRIEF DESCRIPTION OF THE DRAWINGS

FIG. 1 is a perspective view of a conventional window blind.

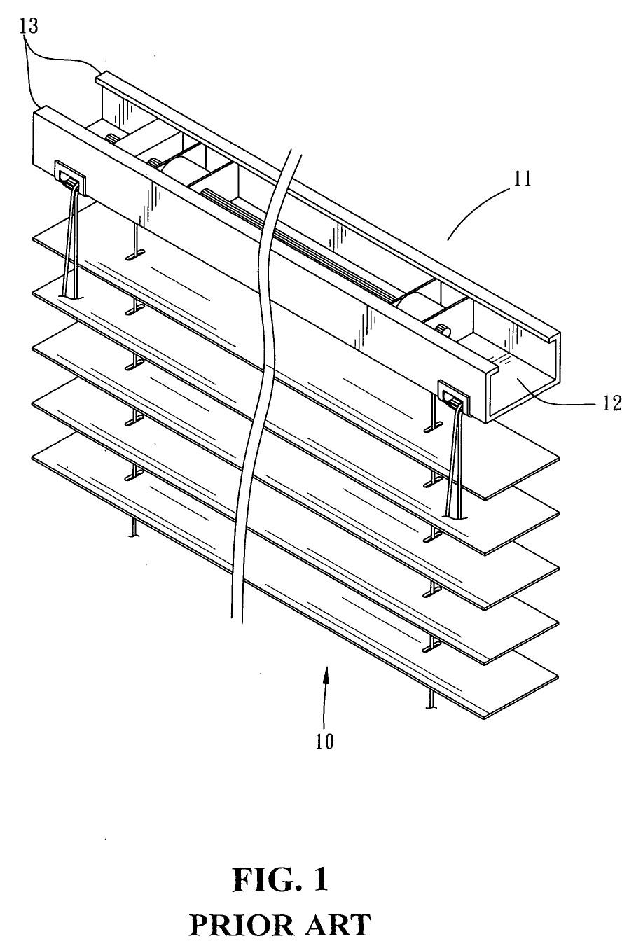

FIG. 2 is a perspective view of another conventional window blind.

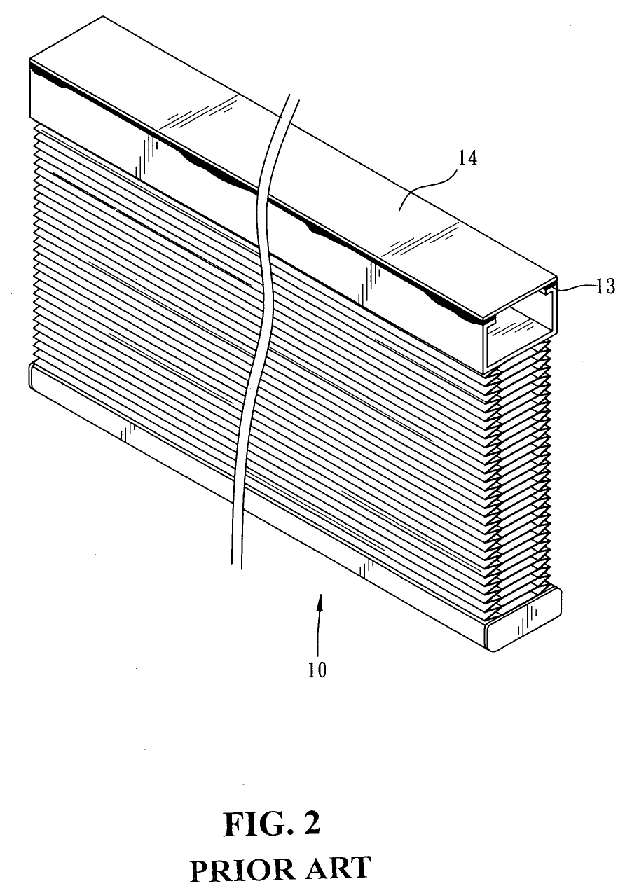

FIG. 3 is an exploded perspective view of the present invention.

FIG. 4 is a perspective view of a positioning seat of the present invention.

FIG. 5 is an assembled perspective view of the present invention.

FIG. 6 is a partially enlarged view of the present invention as shown in FIG. 5.

FIG. 7 is an assembled cross sectional view of the present invention in FIG. 5.

FIG. 8 is a diagram showing a dismantling operation of the present invention.

FIG. 9 is a perspective view of the present invention applied to a vertical-type blind.

FIG. 10 is a perspective view of the present invention applied to a honeycomb blind.

### DETAILED DESCRIPTION OF THE PREFERRED EMBODIMENTS

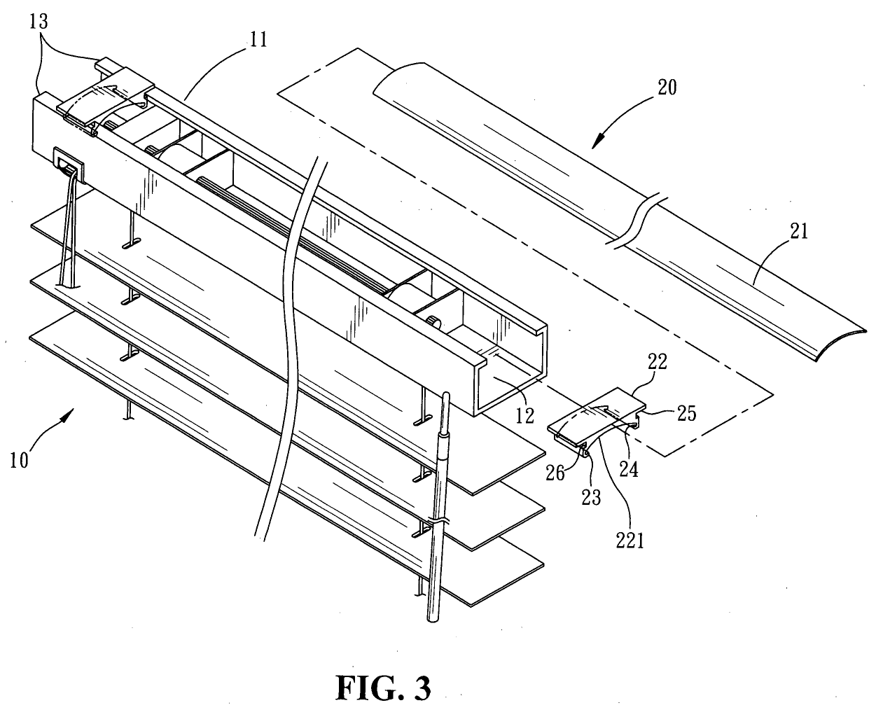

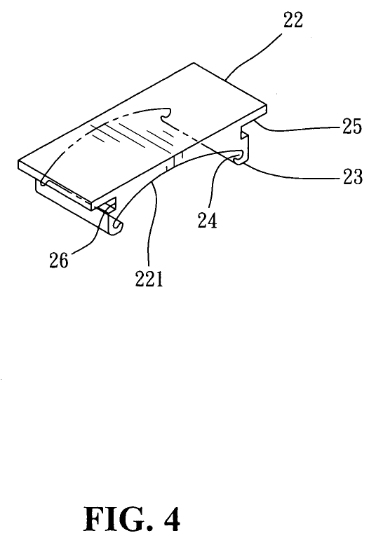

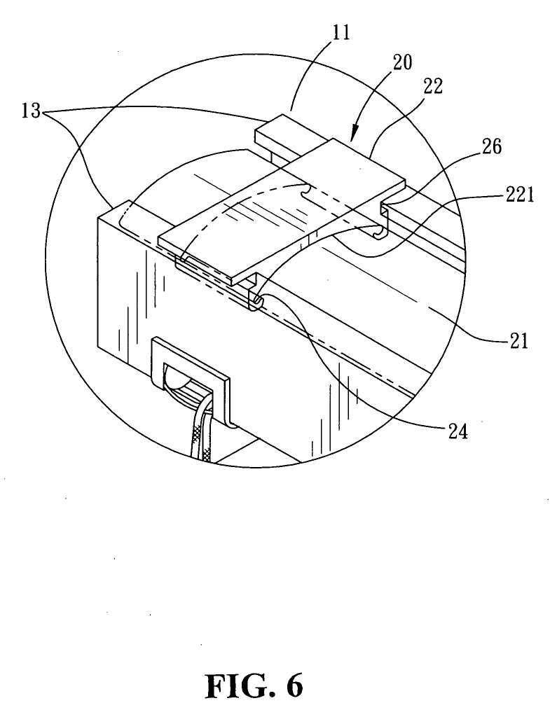

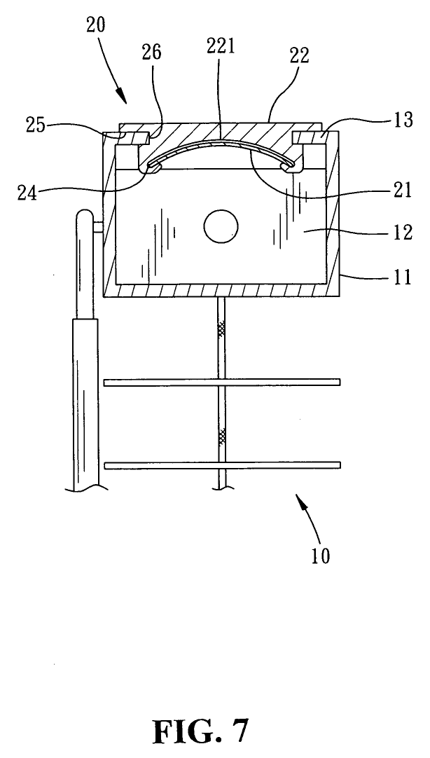

Please refer to FIG. 3 showing an exploded perspective view of the present invention (accompanied by FIGS. 4 through 7 inclusive). The present invention relates to a covering bracket for blinds, comprising a blind 10, a headrail 11, and a covering bracket 20 mounted to a track 13 of the headrail 11. The covering bracket 20 is made up of an arcuate-surfaced sealing cover 21 and multiple positioning seats 22. Each positioning seat 22 is equipped with a curved surface 221 defining one side to match to the sealing cover 21 thereby, and a set of elastic hooked legs 23 symmetrically extending at both lateral edges of the one side thereon. The hooked leg 23 has an inner side matching to the curved surface 221 to form an indented lug-like sliding surface 24 to which the sealing cover 21 can be mounted and engaged therewith. Besides, the positioning seat 22 also includes a set of level-surfaced stop flanges 25 protruding at both lateral edges of the other side thereon, and a set of guide recesses 26 symmetrically indented beneath the stop flanges 25. The guide recesses 26 of the positioning seat 22 can be guided from both ends of the headrail 11 to slide inwards along the track 13 for positioning on the headrail 11, permitting the stop flanges 25 to precisely abut against the top surface of the track 13 and firmly locate astride on top of a grooved portion 12 of the headrail 11 thereon. Then, via the sliding surfaces 24 of the hooked legs 23 thereof, the sealing cover 21 can be smoothly guided along the curved surface 221 of the positioning seat 22 and located in place so as to conceal the grooved portion 12 and achieve the purposes of dustproof and protection of assembling parts mounted inside the headrail 11 thereby. Meanwhile, the positioning seat 22 utilizes the hooked legs 23 and guide recesses 26 to respectively match to the sealing cover 21 and the track 13 of the headrail 11 for mutual engagement thereby so that the covering bracket 20 can be flexibly assembled in an easy manner and firmly mounted to the track 13 of the headrail 11, boosting the appearance of the track 13 of the headrail 11 and decorating the blind 10 as well.

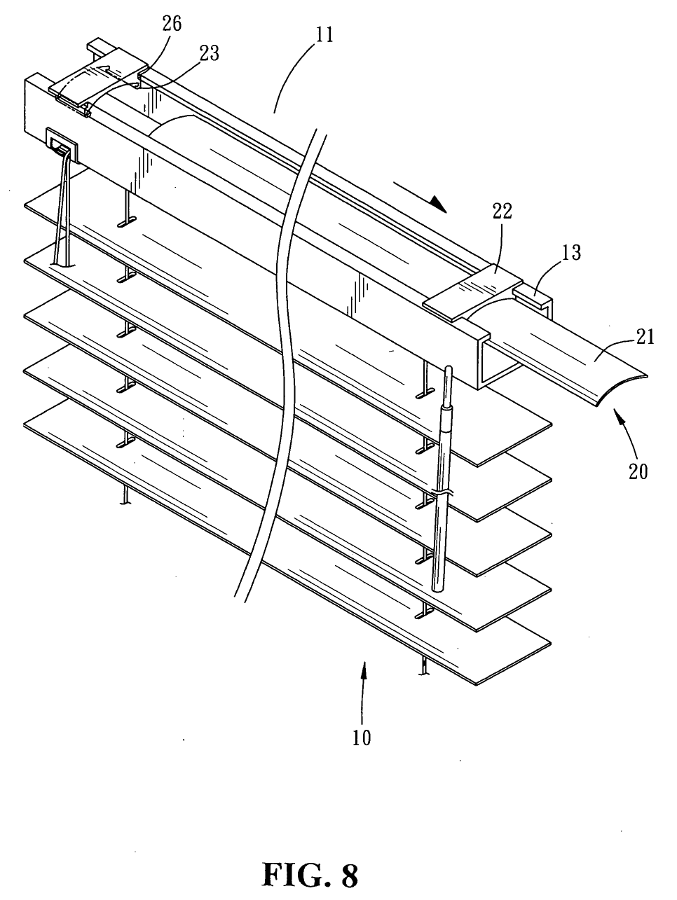

In application, the blind 10 can have the grooved portion 12 of the track 13 easily cleaned and maintained. Please refer to FIG. 8. The positioning seat 22 utilizes the hooked legs 23, the stop flanges 25, and the guide recesses 26 to respectively match to the sealing cover 21 and the track 13 of the headrail 11 so that the covering bracket 20 can be freely moved and slid into position on the headrail 11 thereby. To dismantle the covering bracket 20, the sealing cover 21 is simply drawn outwards to glide along the sliding surfaces 24 of the positioning seat 22 till retrieved from the headrail 11. And, the positioning seat 22 can also be guided along the track 13 and withdrawn outwards till detached there-from. Thus, the covering bracket 20 can be easily dismantled from the headrail 11. Then, the headrail 11 can have the assembling parts accommodated inside the grooved portion 12 of the track 13 maintained and cleaned in an easy and speedy manner. The covering bracket 20 of the present invention can avoid the risks of tearing damage and glue remains left on the track 13 as found in the covering-plate of the above-mentioned conventional blind structure, as well as reduce the time required for cleaning and maintenance to achieve the best application state thereby.

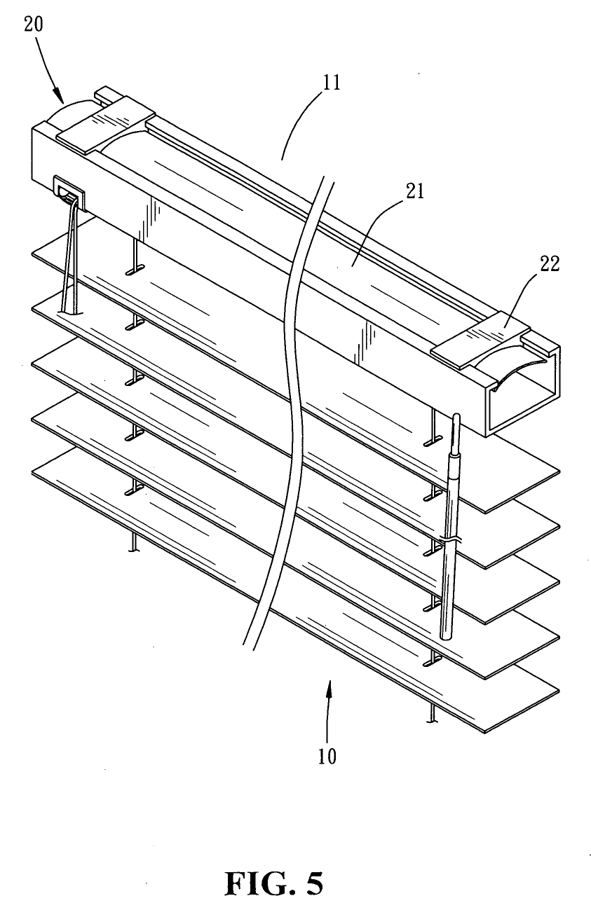

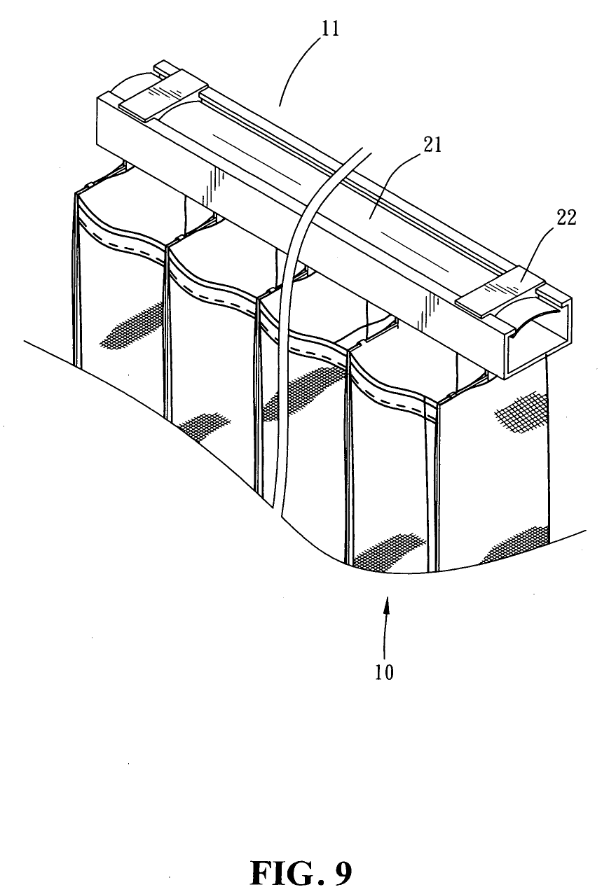

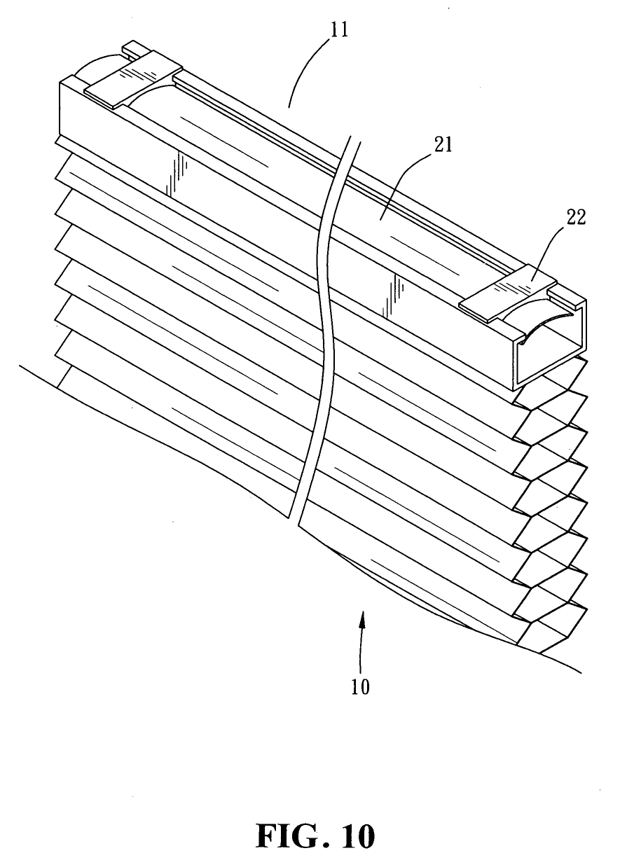

Please refer to FIGS. 8, 9, 10. The covering bracket 20 can be flexibly applied to a wide variety of blinds 10 with headrails 11 of different sizes and standards, including blinds 10 such as a horizontal-type blind as shown in FIG. 5, a vertical-type blind as shown in FIG. 9, and a honeycomb blind as shown in FIG. 10, etc. And the sealing cover 21 can be also matched to different-sized positioning seats 22 and reciprocally mounted to the sliding surfaces 24 accordingly. Therefore, the headrail 11 of the blind 10 can utilize the covering bracket 20 to conceal the grooved portion 12 and avoid the risk of dust and dirt accumulating and attaching onto the assembling parts accommodated therein so that the blind 10 will be more durable in application as well as easier to assemble or dismantle, achieving economical efficiency thereby.

What is claimed is:

1. A covering bracket for blinds, comprising a sealing cover and multiple positioning seats wherein each positioning seat is equipped with a set of elastic hooked legs symmetrically extending at both lateral edges of one side thereon for the engagement of the sealing cover therewith; besides, the positioning seat also includes a set of stop flanges symmetrically protruding at both lateral edges of the other side thereon to precisely locate astride on top of a track of a headrail so that the sealing cover can be positioned in place to conceal a grooved portion of the headrail, achieving the purposes of dustproof and protection of the assembling parts accommodated therein.

2. The covering bracket for blinds as claimed in claim 1 wherein the sealing cover is shaped in an arcuate-surfaced configuration.

3. The covering bracket for blinds as claimed in claim 1 wherein the positioning seat is equipped with a curved surface defining one side to match to the sealing cover thereby, and the hooked legs are provided symmetrically extending at both lateral side edges of the curved surface; each hook leg has an inner side matching to the curved surface to form an indented lug-like sliding surface thereby.

4. The covering bracket for blinds as claimed in claim 1 wherein each stop flange of the positioning seat is shaped in a level-surfaced configuration.

5. The covering bracket for blinds as claimed in claim 1 wherein the positioning seat also has a set of guide recesses symmetrically indented beneath the stop flanges to precisely match to the track of the headrail thereby.
